(19) United States
(12) Patent Application Publication
(10) Pub. No.: US 2009/0307870 A1
(43) Pub. Date: Dec. 17, 2009

(54) Advertising housing for mass transit

(76) Inventor: Steven Randolph Smith, Calgary (CA)

Correspondence Address: Antony C. Edwards, P.O. Box 26020, Westbank, BC, V4T 2G3, CA

(21) Appl. No.: 12/213,139

(22) Filed: Jun. 16, 2008

(51) Int. Cl. G09F 19/00

(52) U.S. Cl. 16/110.1

(57) ABSTRACT

Advertising is mounted for viewing in a rigid hollow housing that surrounds or otherwise encompasses a handle strap that at its upper end is attached to an overhead bar or rail on a bus, train or the like, and that has a lower end which is passed down through the middle of the housing so as to project a lower handle-end of the strap from the bottom of the housing. A hand-hold of toroidal or other shape, may be inserted at, or mounted to, the handle-end of the strap. The hand-hold may be sized to keep the housing from falling off the end of the strap.

### FIELD OF THE INVENTION

This invention relates to the field of advertising to consumers generally and in particular to a housing device for advertising to passengers using mass transit where the form of mass transit requires at least some passengers at some times to remain standing, the passengers supporting themselves by rigid support bars or the like provided in the vehicles.

### BACKGROUND OF THE INVENTION

Bus, trains, subways and like mass public transit carry thousands of commuters and other travelers daily. Often passengers are forced to stand, and so hand-holds, bars, flexible tethers, and other forms of handles and supports are provided to help the passengers keep themselves upright during stop/start of travel. Advertising agencies are continually trying to find the right medium to appeal to their target audience. A lot of commuter/traveler facilities such as stations, airports, etc. provide a particular demographic or target audience that is advertised to by billboards, signs, posters, monitors, television and the like. Although such billboards, signs, etc. proliferate around such facilities, the sophistication with which they target their audience is limited to appealing to crowds passing by. It is known to hang relevant ads from fixed structures or run promotion campaigns in certain areas where commuters have to stand while waiting, for example, on train platforms, bus shelters, etc. however, even these efforts do not reach one untapped portion of the mass audience of people who commute each day in vehicles in which passengers often have to stand, with the exception of the limited advertising space presently available, typically on the walls, ceilings or seat-backs of such vehicles.

Moreover, owners and managers of bus fleets, trains, subways, etc. do not want to be encumbered with additional headaches and management of their vehicles which come with additional traditional signage advertising. These owners and managers are particularly interested in low overhead and maintenance.

In the prior art applicant is aware of Japanese published Patent Application, Publication No. JP6127380, published May 10, 1994 which describes an advertisement display body consisting of two separable cases, with aperture holes on one case and hooks on the other case which would insert into the aperture holes. It is taught that to change the ad, the straps through the advertising box do not need to be taken off the rail in the public transport, but rather to separate the two cases and insert a new advertisement, while the hand strap remains connected to the rail.

In the prior art applicant is also aware of published Japanese Patent Application, Publication No. JP5278525, published Oct. 26, 1993 which describes a U-shaped device used to temporarily guide the correct placement of an advertisement on an advertisement display body. The advertisement paper which is to be adhesively mounted to the advertisement display body, is temporarily mounted within the U-shaped device using projections on the U-shaped device which mount into holes on the advertisement. The advertisement may then be accurately positioned and mounted around the display body. The advertisement is then removed from the projections and from the U-shaped device.

Also in the prior art, applicant is aware of Japanese Patent Application, Publication No. JP9097028 published Apr. 8, 1997, which discloses a rigid pin used to attach to a hand strap a soft sheet-type advertisement body having a hole on each side. To the best of Applicant's knowledge, the pin suspends from a loop in the hand strap so that the advertisement body hangs down along the lower length of the strap, above a handle.

Also in the prior art Applicant is aware of a published United States Patent Application, Publication No. 2007/0079478, published Apr. 12, 2007 for the Hand Grip of Gordienko et al. Gordienko discloses a hand grip made from a plate which is provided with a slot for introducing and extracting a card. A belt suspends the top of the plate from a cross-bar. A handhold is formed in the bottom of the plate.

Applicant is also aware of published Canadian Patent Application No. 2,453,679, published Jun. 18, 2005, for the Advertising Display of Klinck. Klinck teaches fastening a substrate containing advertising indicia to a passenger assist strap and in particular discloses fastening a board by a U-shaped bracket to a neck of the strap. The board is disclosed as hanging down from the fastener at the neck alongside the looped handle portion of the strap.

Applicant is also aware of U.S. Pat. No. 2,277,088 which issued Mar. 24, 1942 to Ehrenhaft for an Advertising Strap Hanger, and U.S. Pat. No. 2,102,488 which issued Dec. 14, 1937 to Sirera for an Advertising Strap Hanger also. Both advertising strap hangers disclose a strap hanger which carries advertising above the hand grip portion, and within a frame of the strap hanger. An advertising plate or plates is secured within the frame from which the hand grip portion depends.

### SUMMARY OF THE INVENTION

The present invention is box-like or other directionally orientable rigid housing in which advertising is mounted and that surrounds or otherwise encompasses a handle strap that is attached to an overhead bar on a bus, train or the like. A hole down the middle of the housing allows the strap to slip through the housing so as to project the handle end of the strap from the bottom of the housing. For example, a plastic ring or other shaped hand-hold may be inserted at, or mounted to, the bottom of the strap to keep the housing from falling off the end of the strap. The housing has a transparent window in the front. Advertising on sheets are mounted behind the glass, for example by means of a planar backing forming a sleeve into which a sheet is slid. In one embodiment the sheet is slid along two opposite channels or tracks located on opposite sides of the front surface. The sleeve or channels allow for advertisements to slide in and out from behind the window. The invention allows transit companies, for example public buses and trains, to increase their advertising space and ultimately their advertising revenue.

In summary, the advertising housing according to the present invention may be characterized in one embodiment as including a strap having opposite first and second ends, a housing adapted for mounting advertising media thereto, wherein said strap extends upwardly from said housing and is adapted for mounting to a rigid support bar in a mass-transit vehicle, and wherein a handle extends downwardly from the housing for grasping by a passenger in said mass-transit vehicle. The housing has at least one display surface for displaying the advertising media to the passenger grasping the handle. The handle lies generally in a plane which is co-planar, and adapted to remain substantially co-planar, with at least a frontal portion of the display surface, whereby the advertising media is directly exposed adjacent to, for viewing by, the passenger grasping the handle and is stabilized for stable viewing of the media by the passenger when the passenger holds onto the handle.

In a preferred embodiment the housing is a hollow housing defining a cavity so that the strap may pass therethrough. The first end of the strap extends upwardly from the housing and is adapted for mounting to the rigid support bar. The second end extends downwardly along and through said hollow housing. The handle is mounted or formed at the second end of the loop.

The housing may have the cavity extending completely therethrough. In a first embodiment at least at a lower end of said housing said cavity is laterally wider than deep as measured front to back. Advantageously, in preferred embodiments the handle and the second end of the strap cooperate to align the housing to stabilize and display a substantially planar display surface towards the passenger grasping said handle for viewing of the planar display surface. In the first embodiment the strap includes a pair of lower portions which are laterally spaced apart in the lower end of the housing so as to flare the lower portions of the strap laterally outwardly in the cavity to thereby assist in substantially aligning the housing for viewing by the passenger.

In another embodiment the hollow housing, with its cavity extending completely therethrough, has at least one of an upper end or a lower end of the housing substantially enclosed by an end wall having at least one slot formed therein. The slot or slots are sized to snugly receive the strap therethrough. The slot or slots are oriented so as to orient a display surface on the housing in a predetermined direction when the housing is suspended on the strap. Where the strap is formed as a loop, a pair of slots which may be parallel, receive the strap therethrough. For example, the loop may be formed at the first end of said strap to loop over a cross-rail hand-hold in a vehicle. The loop may also extend to the second end of the strap so as to mount the handle on the second end of the strap. The handle may have an aperture and the second end of said loop may be looped through said aperture. The housing may be slidably mounted on the strap or loop of the strap the handle may provide a stop to support the housing suspended on the strap or loop of the strap.

In one embodiment one or more of the display surfaces is substantially planar. The slot or slots may be substantially parallel to the planar display surface.

Advantageously the planar display surface is substantially transparent and the media is mounted behind the planar display surface for the viewing therethrough. In one embodiment the housing has an oppositely disposed pair of the planar display surfaces, oppositely disposed on opposite walls of said housing. The housing may be a rectangularly-shaped tube having a rectangular lateral cross-section therealong. The housing may also include backing members mounted behind the planar display surfaces for supporting the media against the planar display surfaces. The backing members and the planar display surfaces may define slots there-between into which the media slidably mounts.

### BRIEF DESCRIPTION OF THE DRAWINGS

In the drawings similar characters of reference denote corresponding parts in each view, and wherein:

FIG. 1 is, in perspective view, one embodiment of the advertising housing according to the present invention.

FIG. 2 is, in front elevation partially cut-away view, the advertising housing of FIG. 1 mounted in cooperation with a tethered handle.

FIG. 3 is, in top plan-form view, the advertising housing of FIG. 1.

FIG. 4 is, in side-elevation view, the advertising housing of FIG. 1.

FIG. 5 is, an alternative and preferred embodiment of the advertising housing according to another aspect of the present invention.

FIG. 6 is, in perspective view, yet a further embodiment of the advertising housing according to the present invention.

FIG. 7 is, in perspective view, yet a further embodiment of the advertising housing according to the present invention.

FIG. 8 is, in partially exploded perspective view, a looped strap as would, in one embodiment, be mounted into an advertising housing according to the present invention.

FIG. 9 is, in perspective view, the embodiment of the advertising housing according to FIG. 5, showing the downward insertion of one end of a strap such as according to FIG. 8, through the advertising housing.

FIG. 10 is the view of FIG. 9 showing the strap completely inserted downwardly through the housing so as to loop through a handle to be suspended below the housing.

FIG. 11 is the view of FIG. 10 showing the end of the strap being reinserted up through the housing after being looped through the handle.

FIG. 12 is the view of FIG. 11 showing the end of the strap having been passed up through the housing.

FIG. 13 is the view of FIG. 12 showing the housing resting down on the handle.

### DETAILED DESCRIPTION OF EMBODIMENTS OF THE INVENTION

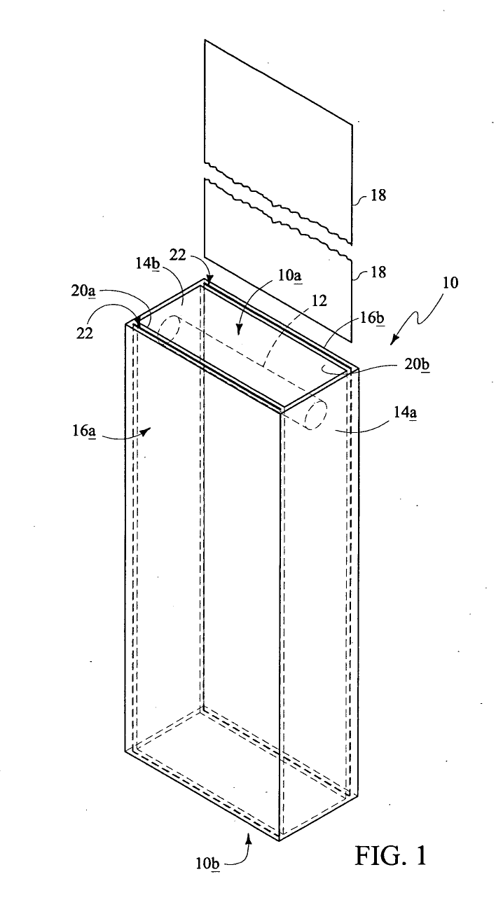

In the illustrated first embodiment of FIGS. 1-4, which is not intended to be limiting, the advertising housing 10 is a hollow rectangular box-like tube having open opposite ends 10a and 10b defining a continuous cavity therebetween. A rigid bar such as rigid dowel 12 is mounted adjacent open end 10a rigidly to so as to extend between sidewalls 14a and 14b. The opposite end 10b is fully (as illustrated) or partially unobstructed.

The opposite front and back walls, 16a and 16b respectively are preferably of transparent or substantially transparent material such as transparent Plexiglas™ or other transparent polymer sheets such as clear acrylic. The transparent front and back walls 16a and 16b provide windows for viewing of an advertising substrate, for example printed sheets 18 mounted behind one or both of the windows in the interior of the housing. In the illustration of FIG. 1, a partially cut-away printed sheet 18 is illustrated slid outwardly from behind back wall 16b, it being understood that sheet 18 is intended to be long enough so as to completely cover behind transparent back wall 16b and also that a second sheet 18 (not shown) is intended to be mounted on the opposite side, that is, behind transparent front wall 16a so as to display the advertising printed on both sheets outwardly from housing 10 through the front and back walls. Advertising may also be affixed to, or mounted behind side walls 14a and 14b where the side walls are opaque or transparent respectively. The sheets may be sized smaller or at least shorter than the length of the front and back walls to inhibit tampering by the public. The sheets may be fed-in and replaced in a linear vertically sliding translation where feeding in one sheet pushes out another from the mounting slot.

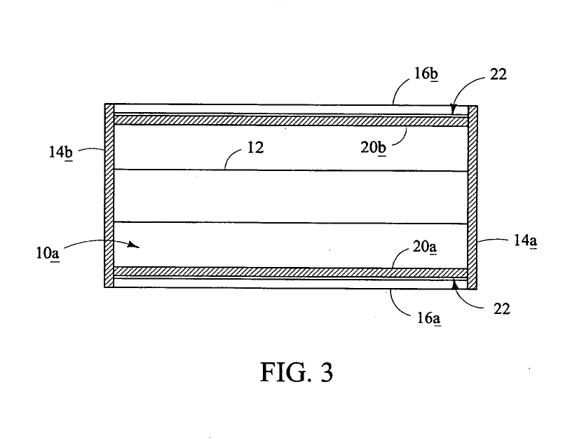

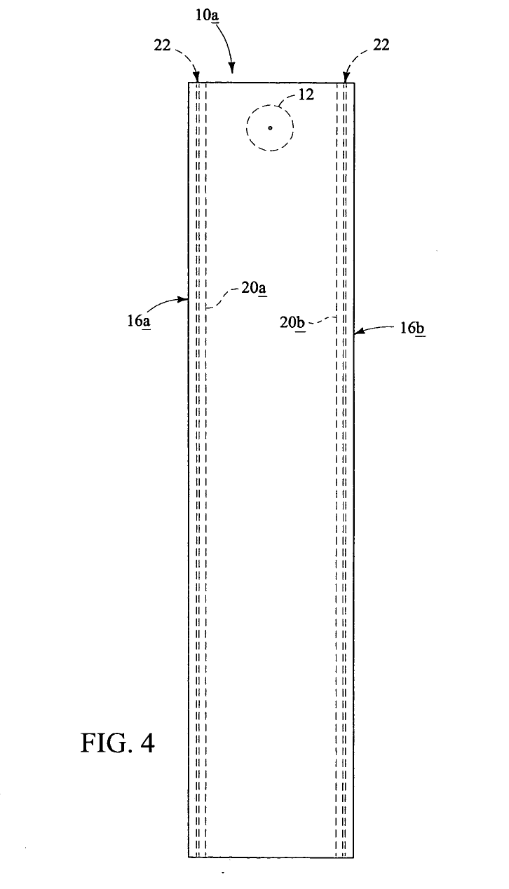

Although it is not intended to limit the advertising media necessarily to printed sheets, as other forms of advertising may be mounted within the housing for viewing by passengers looking upon the front or back walls 16a or 16b, where for example the advertising media may be animated, may be electronic screens, may be backlit artful advertising whether animated or not, and any other form of advertising that may be viewed through a transparent screen and held within a rigid housing having the hollow cavity extending between the open ends 10a and 10b, the only variation between those embodiments and that illustrated herein is the manner in which the advertising media is mounted behind the front and back walls. In the illustrated embodiment, the printed sheets 18 are mounted behind the front and back walls 16a and 16b by sliding the sheets between a pair of slots, or for example into a thin planar sleeve. The sleeve may be formed between the interior surfaces of the front and back walls 16a and 16b and corresponding rigid backing plates 20a and 20b. A thin sheet 18 of printed advertising may be slid into the slot and pushed down along the length of the sleeve so that the entire length of sheet 18 is contained within the corresponding slotted sleeve 22 as better seen in FIGS. 3 and 4.

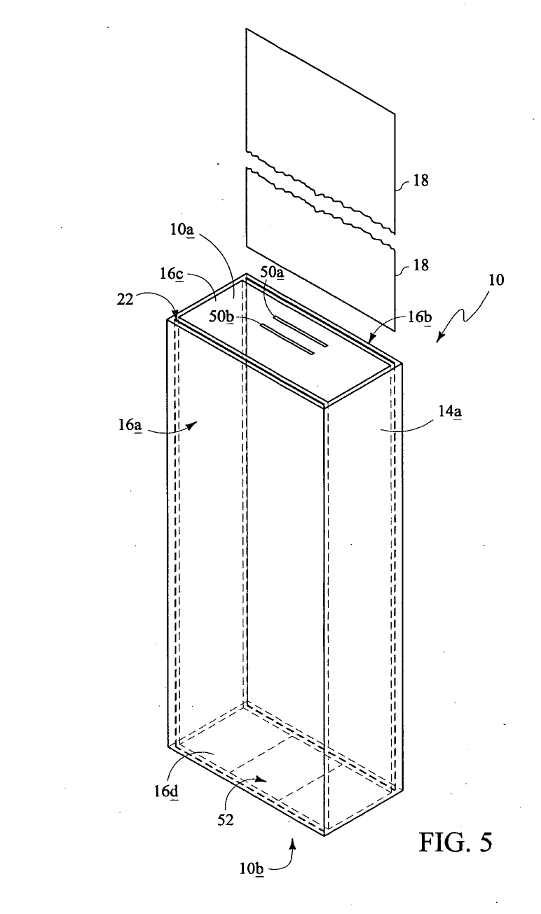

Advertising housing 10 is supported within the confines of a bus, train, subway or the like, by means of a flexible strap 24 such as a leather strap or other durable flexible strap holding up the housing in this embodiment, which is not intended to be limiting, by means of bar or dowel 12 so as to be suspended from a rigid support bar or cross-rail 26 such as typically found extending horizontally within the cabins of buses, trains, subways and the like. Bars 26 are provided so that passengers may grasp the bar for stability during the typical stop and start travel encountered in such mass transit. Advantageously, housing 10 may also be adapted to be tamper-proof for example in the following embodiments of FIG. 5 onwards by enclosing or encasing open ends 10a and 10b to only allow the strap and handle to protrude therethrough respectively and to provide a more secure strap fastener for fastening the ends of the strap.

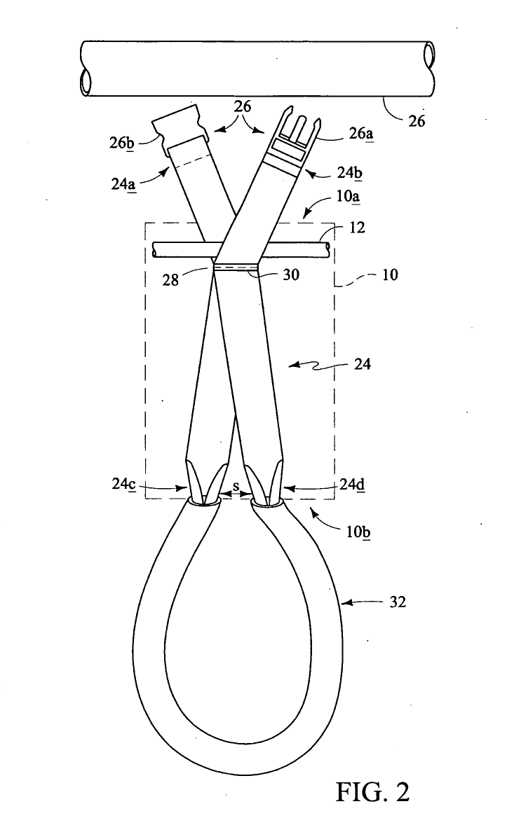

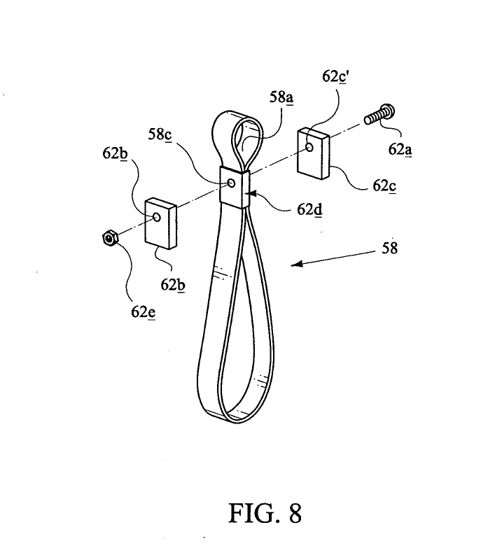

In the illustrated embodiment, which is not intended to be limiting, and as better seen in FIG. 2, strap 24 is a single length of flexible strapping extending in an elongate oval or u-shape so as to depend downwardly between the opposite ends 24a and 24b of strap 24. In the illustrated embodiment, again which is not intended to be limiting, latch 26 having male and female ends 26a and 26b respectively allow the ends of strap 24 to be joined once looped over bar 26. Advantageously the latch is not releasable by members of the public and is adapted only to be released by a properly equipped technician. Other forms of fasteners, such as illustrated by way of example in FIG. 8 may advantageously be used as would be known to one skilled in the art.

Strap 24 is suspended from bar 26 so that, with bar or dowel 12 mounted between ends 24a and 24b of strap 24 and in particular so as to be supported at vertex 28 where the two ends of strap 24 are fastened to one another for example by means of stitching 30, advertising housing 10 is thereby supported resting within vertex 28 and depending therefrom so as to be suspended above resilient looped hollow handle tubing 32 through which strap 24 has been journalled. Thus strap 24 continues as one continuous length between ends 24a and 24b, and at its lowermost extremity loops through hollow handle 32 which in the illustrated embodiment is shown as a resilient or flexible length of hollow tubing but is not intended to be limiting as other forms of handles would work whether hollow or not. Where in an alternative embodiment, handle 32 is not hollow, strap 24 would not be a continuous length of strap but would rather be two sections of strap, the lowermost ends of which, would mount to the handle which protrudes from the bottom of housing 10.

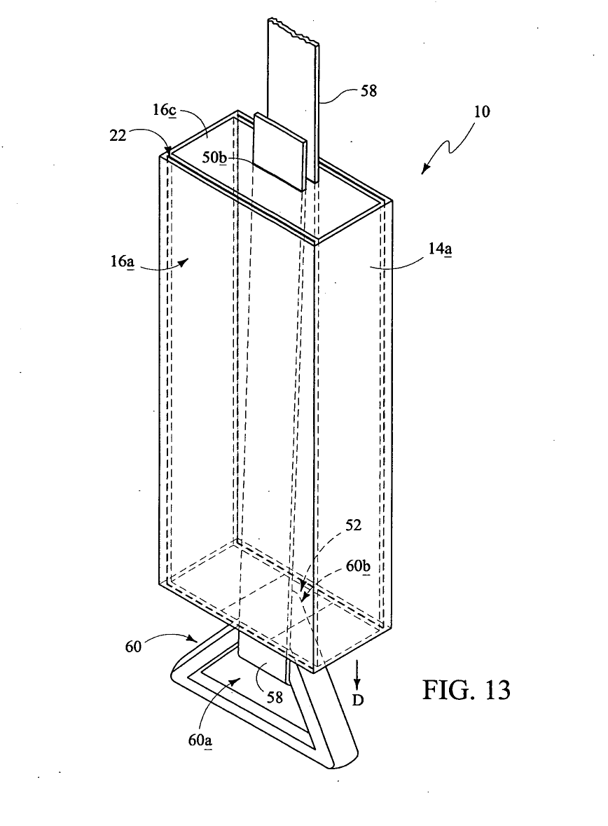

Advantageously, no matter what form of handle 32 is employed, if the lower sections 24c and 24d of strap 24 are maintained with a lateral spacing s, that is, so that the lower portions of strap 24 are laterally spaced apart as illustrated in FIG. 2 or spaced apart front-to-back as seen in FIG. 13, when a user is grasping handles 32 or 60, the spaced apart strap 24 within the hollow cavity of housing 10 and in particular at end 10b, maintains the orientation of housing 10 so that the advertising display seen through either front or back wall 16a or 16b is maintained stably for ease of viewing by the passenger grasping the handle. Thus the advertising displayed through the front and back wall 16a and 16b is not only maintained relatively stable for viewing by the passenger, but is also maintained at a relatively close distance to the face and eyes of the passenger so as to increase the immediacy and impact of the advertising being displayed.

Although not illustrated, in embodiments referred to above, where the advertising displays need to be electrically powered, it is intended to be within the scope of the present invention to provide for example built-in batteries and circuitry as would be known to one skilled in the art for signal processing within the hollow cavity of housing 10 where it will not interfere with strap 24 or be abraded by the motion of strap 24, as handle 32 may move a small amount relative to housing 10 during normal usage.

In alternative embodiments as seen commencing in FIG. 5, housing 10 has a parallel pair of upper slots 50a and 50b formed in upper wall 16c at the upper end 10a of the housing. On the opposite end 10b of housing 10, the lower wall 16d has an opening 52 formed therein which as illustrated is a rectangular aperture although this is not intended to be limiting as other shaped apertures will work. Upper and lower walls 16c and 16d respectively enclose the opposite ends 10a and 10b respectively of housing 10.

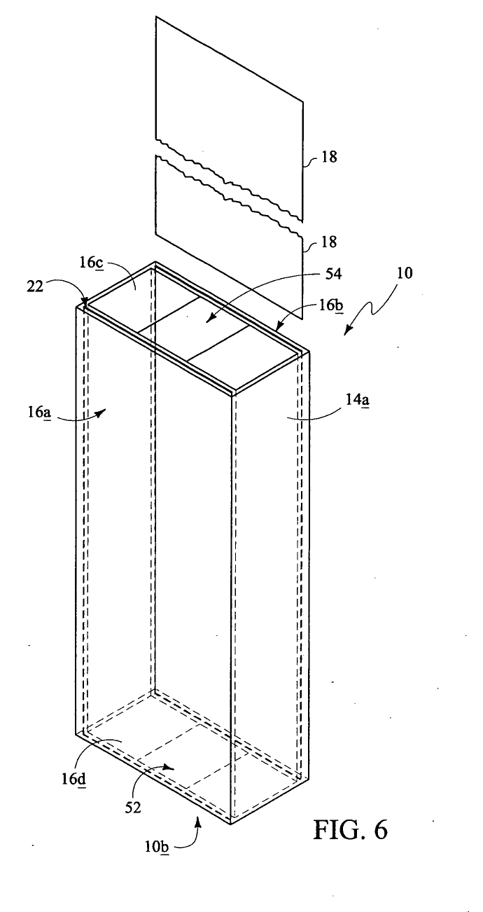

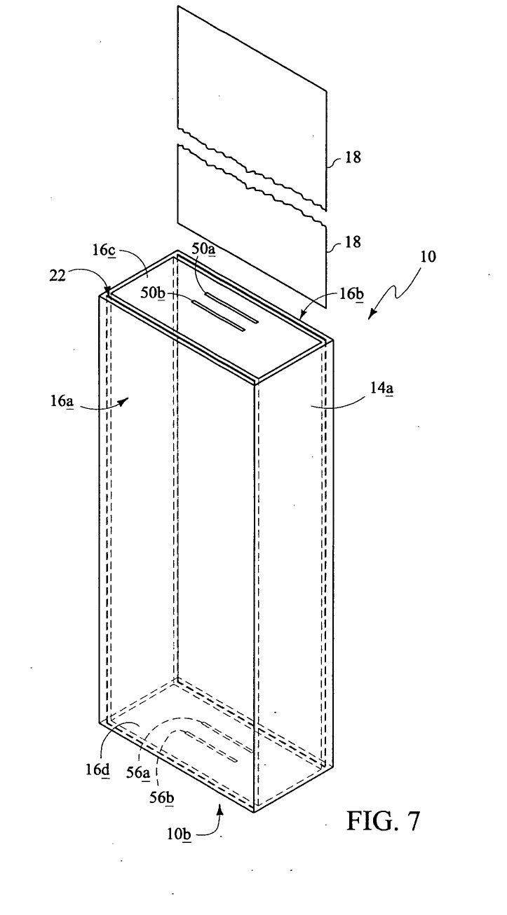

In the alternative embodiment of FIG. 6, an opening 54 is formed in upper wall 16c instead of slots 50a and 50b. In the embodiment of FIG. 7, lower slots 56a and 56b are formed in lower wall 16d instead of opening 52.

In each of the embodiments of FIGS. 5-7, an elongate leather strap 58, or a similar strap of durable flexible material is provided. Leather strap 58 has opposite first and second ends 58a and 58b respectively, and mounts at the first end to support bar 26 and at its opposite second end to a rigid handle such as handle 60 so as to support housing 10 between bar 26 and handle 60 as better described below. In particular, first end 58a of strap 58 is wrapped around bar 26 so as to overlap the first end back on to strap 58. A fastener secures the loop such as would be known to one skilled in the art. For example the fastener may be a nut and bolt arrangement, 62a, 62b respectively, which clamps a bar or washer 62c against first end 58a and second end 58b, which has been looped as described below, so as to lie flush against the back of the mid-portion 58c of strap 58.

Second end 58a of strap 58 is looped through housing 10. For example second end 58b is fed down through a first upper slot 50a, and downwardly through lower opening 52. End 58b is fed through the opening 60a in handle 60 and then returned upwardly back through lower opening 52. End 58b is then fed upwardly through slot 50b for fastening clamped to the back of mid portion 58c along side first end 58a. With strap 58 so looped over bar 26 and through housing 10 and the opening in handle 60, housing 10 is then free to slide downwardly over the looped strap 58 so as to rest down onto handle 60 where the uppermost end of the handle 60b engages against, and in some embodiments up into lower opening 52.

In the embodiment of FIG. 7, although more difficult to feed strap 58 through the upper and lower slots in the housing, the strap may still be looped down through housing 10 so as to loop through the opening 60a in handle 60 at its lower end of the loop, and upwardly over bar 26 at the upper end of the loop so as to support housing 10 on the loop of strap 58. Again housing 10 is free to slide downwardly until the upper end 60b of handle 60 engages against the lower end of housing 10, and in particular in the embodiment of FIG. 7 against the lower surface of lower wall 16d.

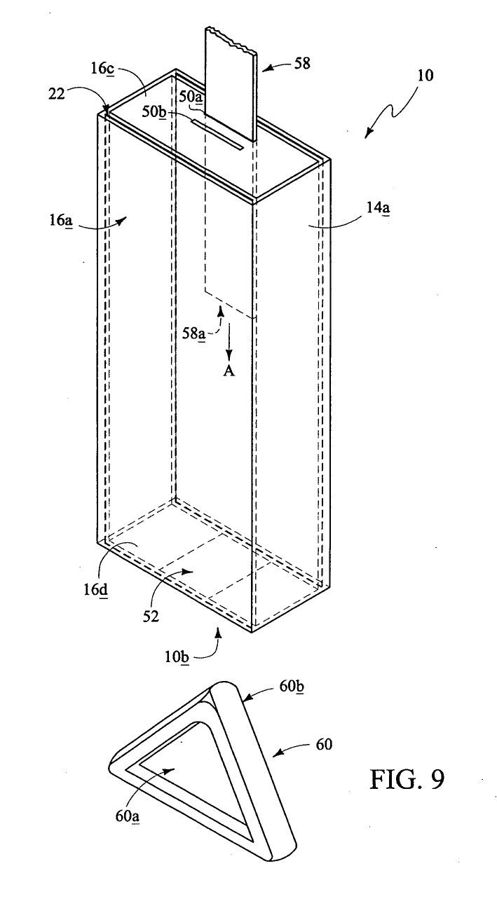

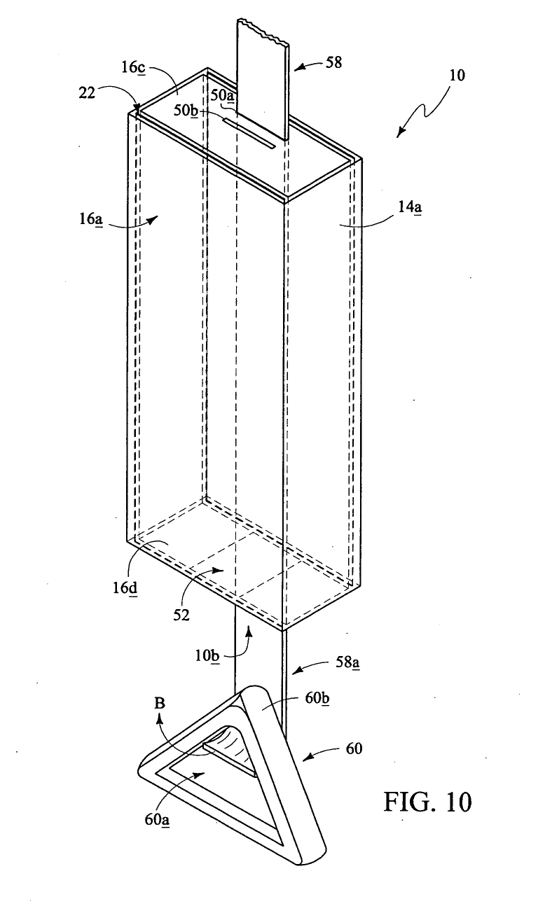

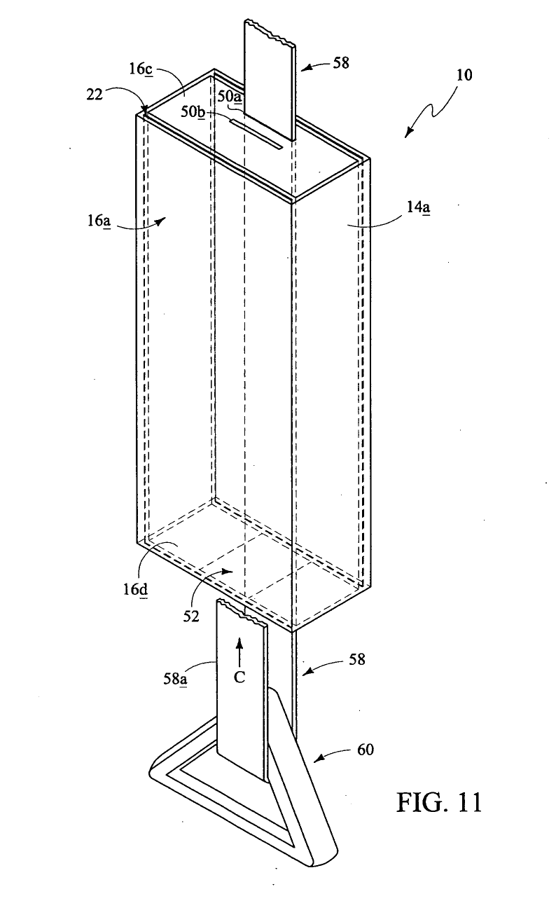

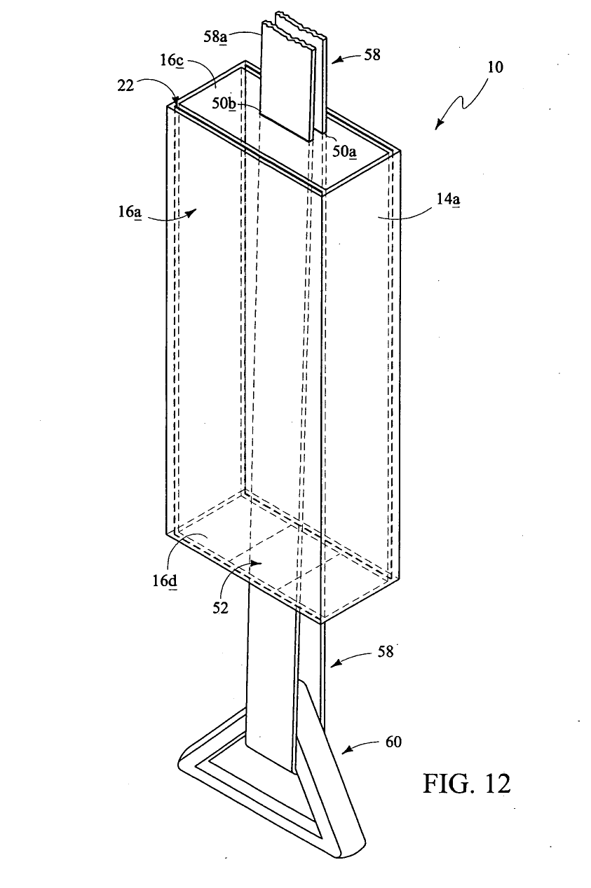

As seen in FIGS. 9-13 the lead end 58a of strap 58 is inserted through slot 50a in the top of housing 10 and fed downwardly in direction A out through the aperture 52 in the bottom end of the housing. The lead end is then fed through the aperture 60a in handle 60 and brought back upwardly in direction B so as to be fed in direction C back up through aperture 52 in the bottom of housing 10. The lead end of the strap 58a is then fed upwardly through the cavity of the housing and upwardly through slot 50b. The lead end 58a of the strap is looped over the cross-bar 26 and clamped to the uppermost end 58b adjacent the mid portion 58c of strap 58 within the clamping mechanism of fasteners 62a-62e. As seen in FIG. 8 in particular, bolt 62a mates with nut 62e so as to clamp washers 62b and 62c on either side of strap collar 62d. Bolt 62a is journalled through holes 62b′ and 62c′ in, respectively, washers 62b and 62c. With strap 58 secured over cross-bar 26, housing 10 may be slid downwardly as seen in FIG. 13, along strap 58 in direction D so as to rest the lower end of housing 10 against the upper end 60b of handle 60.

In the illustrated embodiment, the upper end 60b of handle 60 protrudes upwardly through aperture 52 until the upper sides of the vertex of the handle engage against the lateral edges of aperture 52 thereby preventing further downward motion of housing 10 in direction D. Handle 60 may be triangular in shape with the vertex of the triangle being the upper end 60b. A “D” shaped handle 60, ring or other hand-hold may be substituted for triangular handle 60.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A strap-mounted advertising housing comprising:
a strap having opposite first and second ends,
a housing for mounting advertising media thereto,
wherein said strap extends upwardly from said housing and is adapted for mounting to a rigid support bar in a mass-transit vehicle,
a handle extending downwardly from said housing for grasping by a passenger in said mass-transit vehicle,
wherein said housing has at least one display surface for displaying said advertising media to the passenger grasping said handle, and wherein said handle lies generally in a plane which is co-planar, and adapted to remain substantially co-planar, with at least a frontal portion of said display surface, whereby said advertising media is directly exposed adjacent to, for viewing by, the passenger grasping said handle and is stabilized for stable viewing of said media by the passenger when the passenger holds onto said handle.

2. The device of claim 1 wherein said housing is a hollow housing defining a cavity and said tether passes therethrough so that said first end extends said upwardly from said housing and is adapted for said mounting to the rigid support bar, and wherein said second end extends downwardly along and through said hollow housing and said handle is mounted or formed at said second end.

3. The device of claim 2 wherein said at least one display surface is a substantially planar display surface.

4. The device of claim 2 wherein said hollow housing has said cavity extending completely therethrough, and wherein at least at a lower end of said housing said cavity is laterally wider than deep, and wherein said handle and said second end of said strap cooperate to align said housing to display said substantially planar display surface towards the passenger grasping said handle for viewing of said planar display surface.

5. The device of claim 4 wherein said strap includes a pair of lower portions which are laterally spaced apart in said lower end of said housing so as to flare laterally outwardly in said cavity to thereby substantially align said housing for said viewing.

6. The device of claim 5 wherein said planar display surface is substantially transparent and said media is mounted behind said planar display surface for said viewing therethrough.

7. The device of claim 6 wherein said housing has an oppositely disposed pair of said planar display surfaces, oppositely disposed on opposite walls of said housing.

8. The device of claim 7 wherein said strap is a continuous length of strap.

9. The device of claim 8 wherein said strap is formed as a u-shape which depends downwardly through said cavity, the upper ends of said u-shape being mountable to one another, looped over the rigid support bar.

10. The device of claim 9 wherein the lower portion of said u-shape extends from a lower end of said housing and is adapted thereby to form at least part of said handle.

11. The device of claim 10 wherein said housing is a rectangularly-shaped tube having a rectangular lateral cross-section therealong.

12. The device of claim 11 wherein said housing includes backing members mounted behind said planar display surfaces for supporting the media against said planar display surfaces.

13. The device of claim 12 wherein said backing members and said planar display surfaces define slots there-between into which said media slidably mounts.

14. The device of claim 2 wherein said hollow housing has said cavity extending completely therethrough and wherein at least one of an upper end or a lower end of said housing is substantially enclosed by an end wall having at least one slot formed therein, wherein said at least one slot is sized to snugly receive said strap therethrough, and wherein said slot is oriented so as to orient a display surface of said at least one display surface in a predetermined direction when said housing is suspended on said strap.

15. The device of claim 14 wherein said at least one slot is a pair of slots for receiving therethrough said strap when said strap is formed at least in part as a loop.

16. The device of claim 15 wherein said loop is formed at said first end of said strap to loop over a cross-rail hand-hold in a vehicle.

17. The device of claim 16 wherein said loop extends to said second end of said strap so as to mount said handle on said second end of said strap.

18. The device of claim 17 wherein said handle has an aperture and said second end of said loop is looped through said aperture.

19. The device of claim 17 wherein said housing is slidably mounted on said strap and wherein said handle provides a stop to support said housing suspended on said strap.

20. The device of claim 15 wherein said pair of slots are substantially parallel to each other.

21. The device of claim 20 wherein said at least one display surface is substantially planer, and wherein said pair of slots are substantially parallel to said at least one display surface, and wherein said loop is formed at said first end of said strap to loop over a cross-rail hand-hold in a vehicle.
